(19) United States
(12) Patent Application Publication
(10) Pub. No.: US 2023/0220205 A1
(43) Pub. Date: Jul. 13, 2023

(54) WAX-LIKE FORMULATIONS OF NATURAL-ORIGIN MATERIALS AND ITS METHOD OF PREPARATION

(71) Applicant: Industrias Alen, S.A. DE C.V., Nuevo León (MX)

(72) Inventors: Dante Martínez Villegas, Nuevo León (MX); Angela Lucía Salazar Vargas, Nuevo León (MX); Gonzalo Torres García, Nuevo León (MX); Lizett Verónica Bonifaz Delgado, Nuevo León (MX); Roberto Hernández Rodríguez, Nuevo León (MX); Federico Augusto Ruiz Ruiz, Nuevo León (MX); Alejandro Rivera Hernández, Nuevo León (MX); Frank Fritz Klaus Hochberger Roa, Nuevo León (MX)

(21) Appl. No.: 17/928,228

(22) PCT Filed: May 28, 2021
(86) PCT No.: PCT/IB2021/000370

§ 371 Date: Nov. 28, 2022

Related U.S. Application Data
(60) Provisional application No. 63/032,040, filed on May 29, 2020.

(51) Int. Cl. C08L 93/04; C08K 5/05; C08K 3/32; C08K 5/105; C08K 5/524; C08J 3/205

(52) U.S. Cl. CPC C08L 93/04; C08K 5/05; C08K 3/32; C08K 5/105; C08K 5/524; C08J 3/2056; C08K 2003/329; C08J 2393/04

(57) ABSTRACT

The present invention relates, in one aspect, to wax-like and lanolin-like formulations derived from natural-origin materials, particularly gum rosin combined with long-chain alcohols/polyols (fatty alcohols), the esters resulting from the esterification of these substances, and the polyols resulting from the hydroxylation of these esters, as well as its methods of preparation. The formulations of this invention maybe used as synthetic/natural wax substitutes in formulations for products, including but not limited to, cosmetics, foods and beverages, lanolin substitutes, adhesives, packaging and pharmaceuticals.

### CROSS-REFERENCE TO RELATED APPLICATIONS

This application claims priority under 35 U.S.C. § 119(e) to U.S. Provisional Patent Application No. 63/032,040, filed May 29, 2020, which is incorporated herein by reference in its entirety.

### TECHNICAL FIELD

The present invention relates to wax-like and lanolin-like formulations derived from natural-origin materials, particularly gum rosin combined with long-chain alcohols/polyols (fatty alcohols), the esters resulting from the esterification of these substances, and the polyols resulting from the hydroxylation of these esters, as well as its methods of preparation.

### BACKGROUND

Rosin esters have been known in the art for many years. For example, the U.S. Pat. No. 10,011,740 B2 discloses rosin esters and compositions thereof, also discloses polymeric compositions comprising such rosin esters, as well as methods of making said rosin esters.

The international application No. WO 2016/161034 A1 describes wax compositions that include a base wax and a rosin oil and methods for making and using same. The wax composition can include a base wax and a rosin oil.

However, the above documents do not disclose the specific wax-like nor lanolin-like formulations as described and claimed in the present invention, neither the method of obtaining such formulations, which, in addition to being a simplified method of obtaining the wax-like or lanolin-like formulations, is also economically more viable compared to the already known methods of obtaining wax or lanolin formulations.

### SUMMARY

One embodiment of the present invention refers to wax-like formulations derived from natural-origin materials, particularly refers to gum rosin combined with long-chain alcohols/polyols (fatty alcohols) and phosphoric acid, and the esters resulting from the esterification of these substances.

Another embodiment of the present invention refers to a one-pot process for preparing the wax-like formulations comprising [1] melting the gum rosin in the reaction vessel with prior adding of an antioxidant to avoid color darkening and under inert atmosphere or inert gas bubbling to further avoid oxidation; [2] adding the selected long-chain alcohol slowly at the mass percentage selected for the particular formulation and it is allowed to melt and mix with the gum rosin, at this point, phosphoric acid is added at a specified mass percentage in relation to the total mass, the temperature in the reaction vessel is then raised accordingly to the desired esterification degree; [3] temperature in the reaction vessel is monitored constantly during the reaction process, and a mild vacuum is applied to remove water produced in the reaction.

Another embodiment of the present invention refers to a polyol resulting from the hydroxylation of the esters obtained from the one-pot process for preparing the wax-like formulations mentioned above. This process involves i) reacting the wax-like esters with different formic acid and hydrogen peroxide ratios under mild temperature conditions, vigorous agitation, different reaction times and an inert atmosphere to further avoid oxidation; ii) adding hydrogen peroxide dropwise and controlling temperature carefully; iii) decomposition of the remaining hydrogen peroxide with an inorganic agent (such as sodium thiosulfate solution) at the end of the reaction time, dissolution of the hydroxylated ester in diethyl ether, neutralization with sodium carbonate solution until neutral pH and evaporation of the solvent under vacuum.

### BRIEF DESCRIPTION OF THE DRAWINGS

FIGS. 1A-1B are illustrations showing the used experimental setups for wax-like materials preparation. According to relative reaction temperature to the boiling point of the alcohol: (FIG. 1A) lower reaction temperatures, (FIG. 1B) near boiling point temperatures.

### DETAILED DESCRIPTION

This invention is susceptible of different embodiments which will be disclosed in detail in the following description and are shown in the drawings, with the understanding that the present description is to be considered as an exemplification of the invention and is not intended to limit the broad aspects of the invention only to the embodiments disclosed and illustrated.

Wax-like materials and formulations derived from natural-origin materials such as gum rosin, long-chain alcohols/polyols (fatty alcohols), the esters resulting from the esterification of these substances, the polyols obtained from the hydroxylation of these esters, as well as its method of preparation, are presented. In certain embodiments, emulsion formation and esterification are aided by the use of phosphoric acid and their reaction products during a one-pot preparation. (See references 8-16). Potential applications as synthetic/natural wax substitutes in formulations for products in (including but not limited to) cosmetics, food and beverage, lanolin substitutes, adhesives, packaging and pharmaceuticals are identified.

Most of commercially available waxes are either petroleum derived or obtained from limited natural resources (e.g. beeswax, lanolin). Concern for sustainable bio-based products has been growing in recent years, therefore the need for shifting to new markets within synthetic and natural waxes. Few vegetable waxes (such as carnauba and candelilla) can be obtained directly from plants and used after a refining process, while other vegetable waxes, such as those derived from vegetable oils, do require chemical modification (1).

Synthetic waxes are typically prepared from petroleum-derived materials (polyethylene, Fischer-Tropsch waxes, etc.) and few of them are considered to be from natural origin or sustainable sources (mainly the ones derived from vegetal oils). Production of these vegetal synthetic waxes typically follow one or some of the following processes: partial/total hydrogenation, transesterification, epoxidation, ring-opening reactions, or amidation (2).

In later years, gum rosin has been receiving attention as raw material for new modified materials with a wide array of applications in coatings, pharmaceuticals, food-grade and antibacterial materials (3), (4), (5) Due to the carboxylic group present in rosin acids, their esterification has been widely studied (6), (7). However, limited studies have been published regarding the possibility of applying such esters to wax-like formulations.

The wax-like materials are prepared in a one-pot process that consists of the following general procedure:

[1] Gum rosin is melted in the reaction vessel with prior adding of an antioxidant (typically but not limited to BHT or Irganox B-225) to avoid color darkening and under inert atmosphere or inert gas bubbling (typically nitrogen) to further avoid oxidation. Temperature is allowed to reach around 100° C. and mixing is started as soon as the material is fluid enough.

[2] The selected long-chain alcohol is added slowly at the mass percentage selected for the particular formulation and it is allowed to melt and mix with the gum rosin. The suitable fatty alcohols can include but are not limited to: stearyl alcohol, cetyl alcohol, 1,10-decanediol, and 1,6-hexanediol or mixtures thereof. At this point, phosphoric acid (concentrated, 85% aqueous solution) is added at a specified mass percentage in relation to the total mass. Temperature is then raised accordingly to the desired esterification degree. Typical values for the produced formulations ranged between 120° C. and 300° C. Similarly, reaction times are varied between 3 and 12 hours according to the desired esterification degrees and to avoid unwanted side reactions (i.e., pyrolysis, oxidation, etc.).

[3] Temperature in the reaction vessel is monitored constantly during the reaction process. A mild vacuum is applied to remove water produced in the reaction. As different alcohols show different boiling points, it is necessary to use different experimental arrangements to avoid loss of alcohol from the reaction vessel.

[4] If further functionalization of any of the resulting embodiments is desired in order to increase the polarity of the material, then a hydroxylation process consisting of the following steps can be followed: i) Adding formic acid (industrial grade 85%) in a 3:1 molar relation to the expected moles of double bonds in the wax-like material, applying vigorous mechanical agitation and mild heating (40° C. to 50° C.); dropwise adding hydrogen peroxide (industrial grade 30%) in a 1.5:1 molar relation to the expected moles of double bonds of the wax-like material for 30 minutes. ii) Raising the temperature to between 60° C. and 65° C. and letting the mixture react for 2 to 4 hours according to the desired degree of hydroxylation. iii) At the end of the reaction time adding a 10% w/v aqueous sodium thiosulfate solution and letting it react with the remaining hydrogen peroxide for 30 minutes under agitation; dissolving the mixture with sufficient ethyl ether to extract the organic phase and neutralizing with a 10% w/v solution of sodium carbonate until neutral pH; evaporating the solvent under vacuum.

According to the present invention, the long-chain alcohol/polyol or fatty alcohol, is usually an alcohol/polyol having from 6 to 40 carbon atoms and can be selected from but not limited to:

cetyl alcohol, stearyl alcohol, UNILIN™ 350 (a fully saturated, long chain C₂₀-C₄₀, linear primary alcohol, with average MW of 375, viscosity of 5.9 cp@99° C., and melting point of 78° C.), UNILIN™ 425 (a fully saturated, long chain C₂₀-C₄₀, linear primary alcohol, with average MW of 460, viscosity of 7.8 cp@99° C., and melting point of 91° C.), 1,4-butanediol, 1,6-hexanediol, 1,10-decanediol, or mixtures thereof. Notwithstanding, formulations may contain lesser quantities or traces of longer-chain primary alcohols of up to 58 carbons.

The antioxidant used in the preparing process of the present invention can be selected but is not limited to: butylated hydroxytoluene (BHT), a blend of tris(2,4-ditert-butylphenyl)phosphite and pentaerythritol tetrakis[3-[3,5-di-tert-butyl-4-hydroxyphenyl]propionate] (commercially available as Irganox B-225 from BASF), or any other substance able to avoid oxidation and color darkening.

In general non-limiting terms, the wax-like formulations of the present invention comprise in percent by weight of the total formulation:
from about 20% to about 86% of gum rosin, preferably from about 47% to about 52%;
from about 12% to about 80% of the fatty alcohol, preferably from about 46% to about 51%;
from about 0.1% to about 4% of phosphoric acid, preferably from about 0.5% to about 2%;
from about 0.1% to about 3% of the antioxidant, preferably from about 0.5% to about 2%.

The present invention includes the following embodiments:

1. A wax-like formulation comprising in percent by weight of the total formulation:
from about 20% to about 86% of gum rosin, preferably from about 47% to about 52%;
from about 12% to about 80% of a fatty alcohol or polyol, preferably from about 46% to about 51%;
from about 0.1% to about 4% of phosphoric acid, preferably from about 0.5% to about 2%;
from about 0.1% to about 3% of an antioxidant, preferably from about 0.5% to about 2%.

2. The wax-like formulation of 1, wherein the fatty alcohol is a long-chain alcohol having from 6 to 40 carbon atoms and may contain lesser quantities or traces of longer-chain primary alcohols of up to 58 carbons.

3. The wax-like formulation of 1, wherein the fatty alcohol is a polyol having from 4 to 40 carbon atoms and may contain lesser quantities or traces of longer-chain primary alcohols of up to 58 carbons.

4. The wax-like formulation of 1, wherein the antioxidant is able to avoid oxidation and color darkening.

5. The wax-like formulation of 4, wherein the antioxidant is selected, but not limited to: butylated hydroxytoluene (BHT), a blend of tris(2,4-ditert-butylphenyl)phosphite and pentaerythritol tetrakis[3-[3,5-di-tert-butyl-4-hydroxyphenyl]propionate] (commercially available as Irganox B-225 from BASF).

6. The wax-like formulation of any of 1 to 5, wherein the fatty alcohol or polyol is selected but not limited to: cetyl alcohol, stearyl alcohol, UNILIN™ 350, UNILIN™ 425, 1,4-butanediol, 1,6-hexanediol, 1,10-decanediol, or mixtures thereof.

7. The wax-like formulation of 6, wherein the fatty alcohol is stearyl alcohol.

8. The wax-like formulation of any of 1 to 7, wherein the antioxidant is BHT or Irganox B-225.

9. A wax-like formulation comprising in percent by weight of the total formulation:
from about 47% to about 52% of gum rosin;
from about 46% to about 51% of stearyl alcohol;
from about 0.5% to about 2% of phosphoric acid;
from about 0.5% to about 2% of BHT or Irganox B-225.

10. A one-pot process for preparing the formulation of 1 or 9, comprising the steps of:
i) melting the gum rosin in the reaction vessel with prior adding of the antioxidant under inert atmosphere, until temperature is around 100° C., then mixing is started as soon as the material is fluid enough;
ii) adding slowly the fatty alcohol or polyol, and let to melt and mix with the gum rosin;
iii) adding the phosphoric acid and let the temperature raises between 120° C. and 300° C. accordingly to the desired esterification degree;
iv) monitoring the temperature in the reaction vessel constantly during the reaction process and applying a mild vacuum to remove water produced in the reaction;
v) letting the reaction proceed at the set temperature for 3 to 12 hours accordingly to the desired esterification degree.

11. The one-pot process of 10, wherein the fatty alcohol is a long-chain alcohol having from 6 to 40 carbon atoms and may contain lesser quantities or traces of longer-chain primary alcohols of up to 58 carbons.

12. The one-pot process of 10, wherein the fatty alcohol is a polyol having from 4 to 40 carbon atoms and may contain lesser quantities or traces of longer-chain primary alcohols of up to 58 carbons.

13. The one-pot process of 10, wherein the antioxidant is able to avoid oxidation and color darkening.

14. The one-pot process of 12, wherein the antioxidant is selected, but not limited to: butylated hydroxytoluene (BHT), a blend of tris(2,4-ditert-butylphenyl)phosphite and pentaerythritol tetrakis[3-[3,5-di-tert-butyl-4-hydroxyphenyl]propionate] (commercially available as Irganox B-225 from BASF).

15. The one-pot process of 10, wherein the fatty alcohol or polyol is selected but not limited to: cetyl alcohol, stearyl alcohol, UNILIN™ 350, UNILIN™ 425, 1,4-butanediol, 1,6-hexanediol, 1,10-decanediol, or mixtures thereof.

16. The one-pot process of 10, wherein the fatty alcohol is stearyl alcohol.

17. The one-pot process of 10, wherein the antioxidant is BHT or Irganox B-225.

18. The wax-like formulation of 1 to 9, which has undergone a hydroxylation process consisting of:
i) adding formic acid (industrial grade 85%) in a 3:1 molar relation to the expected moles of double bonds in the wax-like material, applying vigorous mechanical agitation and mild heating (40° C. to 50° C.);
ii) adding hydrogen peroxide dropwise (industrial grade 30%) in a 1.5:1 molar relation to the expected moles of double bonds of the wax-like material for 30 minutes.
iii) raising the temperature to 65° C. and controlling the temperature for 2 to 4 hours according to the desired degree of hydroxylation.
iv) at the end of the reaction time adding a 10% w/v aqueous sodium thiosulfate solution and letting it react with the remaining hydrogen peroxide for 30 minutes under agitation;
v) dissolving the mixture with sufficient ethyl ether to extract the organic phase and neutralizing with a 10% w/v solution of sodium carbonate until neutral pH; evaporating the solvent under vacuum.

### EXEMPLARY EMBODIMENTS

Detailed below are six exemplary wax-like formulations based on stearyl alcohol. Examples 1 and 2 are solid at room temperature with a homogenous appearance and a slight tacky texture. Example 3 and 4 has a light yellowish lanolin-like (viscous liquid) appearance at room temperature, with almost no apparent tack and a very oily texture. Example 5 is a deep red oily liquid at room temperature with silky texture. Example 6 is a wax-like semi solid at room temperature with a deep red-brown color and a silky texture. All formulations are insoluble in water. Formulations 1, 2 and 6 are insoluble in isopropanol. Formulations 3, 4 and 5 are only partially soluble in isopropanol. All formulations are soluble in toluene.

All the formulations comprise:
From about 47% to about 52% gum rosin, specifically 49.5%
From about 46% to about 51% stearyl alcohol, specifically 48.5%
From about 0.5% to about 2% of phosphoric acid, specifically 1%
From about 0.5% to about 2% of BHT or Irganox B-225, specifically 1%

TABLE 1
EXAMPLE FORMULATIONS AND
THEIR CHARACTERISTICS

| | Acid number, | OH number, | Congealing | Hardness, |
|---|---|---|---|---|
| | mgKOH/g | mgKOH/g | point, ° C. | dmm |
| Example 1 | 81.46 | — | 46.0 | 24.0 |
| Example 2 | 91.81 | — | 45.7 | 15.67 |
| Example 3 | 7.60 | 9.2 | 38.7 | N/A |
| Example 4 | 8.16 | 16.2 | 40.3 | N/A |
| Example 5 | 0.59 | 0.23 | 23.2 | N/A |
| Example 6 | 1.86 | 74.6 | 41.2 | N/A |

*Acid number and hardness measured at room temperature according to ASTM D465-15 and ASTM D1321 respectively. OH number obtained according to ASTM E1899. Congealing point measured according to ASTM D938

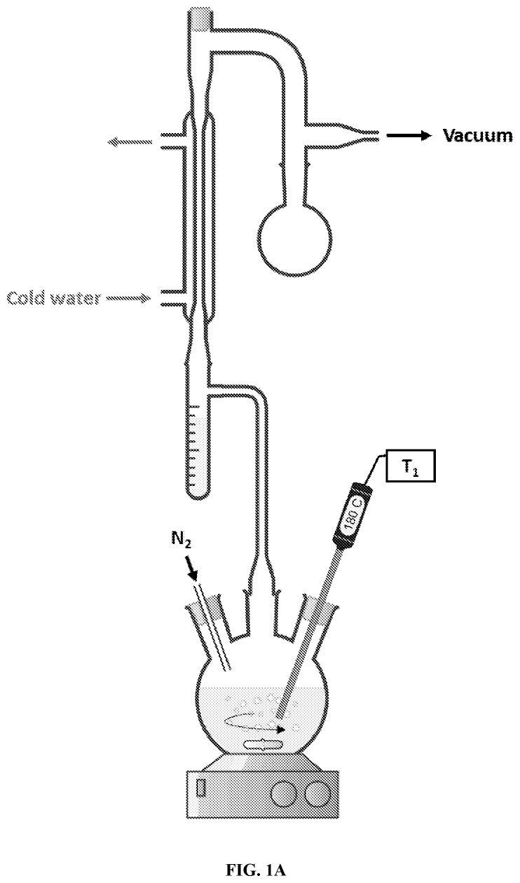

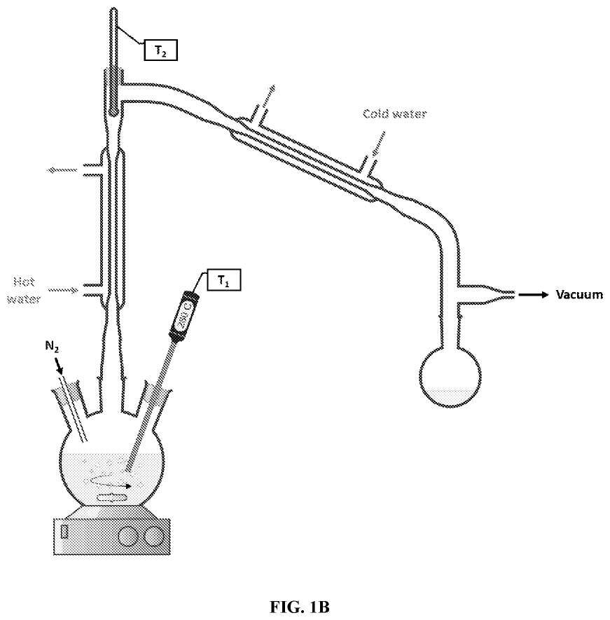

Examples 1 and 2 may be made with the experimental setup shown in FIG. 1A. Example 1 may be made by following the procedure described in [1] through [3]. Temperature is controlled to range between 175-185° C. The mixture is allowed to react for 8 hours and then poured out of the reaction vessel into the desired container and let cool.

Example 2 may be made by first melting stearyl alcohol and controlling temperature to remain around 120° C. Once temperature is stable, phosphoric acid (Industrial grade 85%) is added in the corresponding proportion under agitation. Temperature and mixing are maintained for 3 hours and then powdered gum rosin is added slowly to the vessel. After all gum rosin is melted inside the reactor, mixing is allowed to continue for 10-15 minutes and then the mixture is poured into the desired container and let cool.

Example 3 may be made with the experimental setup shown in FIG. 1B. Temperature is controlled between 275 and 285° C. and the procedure in [1] to [3] is followed, with particular attention to maintaining an inert atmosphere throughout the reaction. The mixture is allowed to react for 8 hours. The mixture is allowed to react for 8 hours and then poured out of the reaction vessel into the desired container and let cool.

Example 4 may be made with the experimental setup shown in FIG. 1B. Temperature is controlled between 260° C. and 270° C. and the procedure in [1] to [3] is followed, with particular attention to maintaining this temperature range and bubbling of inert gas throughout the reaction. The mixture is allowed to react for 7 hours and then poured out of the reaction vessel into the desired container and let cool.

Example 5 may be made with the experimental setup shown in FIG. 1B. Temperature is controlled between 285° C. and 295° C. and the procedure in [1] to [3] is followed, with particular attention to maintaining this temperature range and bubbling of inert gas throughout the reaction. The mixture is allowed to react for 8 hours and then poured out of the reaction vessel into the desired container and let cool. The resulting material is let settle for 24 hours and the upper phase is used.

Example 6 may be made with the experimental setup shown in FIG. 1B. Temperature is controlled between 260° C. and 270° C. and the procedure in [1] to [3] is followed, with particular attention to maintaining this temperature range and bubbling of inert gas throughout the reaction. The mixture is allowed to react for 7 hours and then poured out of the reaction vessel into the desired container and let cool. This material is then heated to 40° C. in a jacketed vessel or water bath and stirred mechanically. To this vessel between 50% and 60% of formic acid (industrial grade 85%) in relation to the total mass of the wax-like material is added; between 30% and 40% of hydrogen peroxide (industrial grade 30%) in relation to the total mass of the wax-like material is dropwise added for 30 minutes. The temperature is then raised to 65° C. and let react for 4 hours. At the end of the reaction time the procedure for hydrogen peroxide consumption, dissolution in ethyl ether, neutralization and evaporation described in [5] is followed.

Each one of the formulations of Examples 1 to 6 exhibited chemical-physic properties similar that the synthetic/natural waxes commonly used in products of different industries. Hence, the products of this invention maybe used as synthetic/natural wax substitutes in formulations of products including cosmetics, foods and beverages, lanolin substitutes, adhesives, packaging, pharmaceuticals, among others.

The present invention has been sufficiently disclosed so that a person with average knowledge in the art can reproduce and obtain the results mentioned in the present specification. However, any person skilled in the art to which the present invention belongs may be able to make modifications and substitutions without departing from the spirit of the invention as defined later in the claims.

### REFERENCES

(1). Marsel, C. J. Waxes. Kirk-Othmer Encyclopedia of Chemical Technology. s.l.: John Wiley & Sons, Inc.

(2). A review of recent development of sustainable waxes derives from vegetable oils. Fei, Tao and Wang, Tong. Iowa: Innovation in food science, 2017.

(3). Synthesis and characterization of novel reduced Gum rosin-acrylamide copolymer-based nanogel and their investigation for antibacterial activity. Jinddal, Rajeev and Sharma, Rachna. s.l.: Springer, 2016.

(4). Rosin: Chemistry, Derivatives, and Applications: a review. Manar El-Sayed Abdel-Raouf, et al. 2018, BIO ACCENT.

(5). Hofer, Rainer. The Pine Biorefinery Platform Chemicals. Industrial Biorefineries and White Biotechnology. 2015, pp. 127-155.

(6). The Kinetics of Esterification of Resin Acids. Smith, Thor L. and Eliott, John H. 1958, The Journal of the American Oil Chemists' Society, pp. 692-699.

(7). Kinetic modelling of the esterification of rosin and glycerol: Application to industrial. Ladero, Miguel and et. al., 2011, Chemical Engineering Journal, pp. 319-328.

(8). U.S. Pat. No. 3,089,782; 1963. COMPOSITION FOR AND METHOD OF APPLYING CERAMIC COLOR. Bush, Donald R., Howarth, Thomas E. and Lawrence, Roy.

(9). U.S. Pat. No. 9,663,670; 2017. WATER REMOVABLE COMPOSITIONS AND APPLICATIONS THEREOF. Wu, Bo and Thomas, Jr., Jule W.

(10). U.S. Pat. No. 10,011,740; 2018. ROSIN ESTERS AND COMPOSITIONS THEREOF. Nelson, Lloyd A, et al.

(11). WO02016115257; 2016. PLASTICIZERS DERIVED FROM POLYCYCLIC ACIDS OR DIMER FATTY ACIDS. Albert, Brian J.

(12). WO2016161034; 2015. WAX COMPOSITIONS CONTAINING DIMER ACIDS AND ROSIN OIL AND METHODS FOR MAKING AND USING SAME. Snead, David R.

(13). GB2124081; 1985. COSMETIC CONTAINING GLYCEROL ESTER OF POLYMERISED ROSIN. Marlene, Tietjen, Tibor, Goldner and Kalyan, K, Basak.

(14). U.S. Pat. No. 4,847,010; 1989. PROCESS FOR PREPARING ROSIN ESTER WITH ESTERIFICATION AND HYDROGENATION. Maeda, Masao and Kodama, Yoshihiro.

(15). U.S. Pat. No. 4,302,371; 1981. STABILIZED ROSIN ESTER AND PRESSURE-SENSITIVE ADHESIVE AND HOT-MELT COMPOSITION BASED THEREON. Matuso, Kohtaro and Tsuchida, Seiichi.

(16). US 2004/0191279 A1; 2004. TACKY SKIN CARE COMPOSITIONS AND ARTICLES HAVING TACKY SKIN CARE COMPOSITIONS DISPOSED THEREON. Klofta, Thomas James.

(17). Monteavaro, Luciane L. and Da Silva, Eduardo O. Polyurethane Networks from Formiated Soy Polyols: Synthesis and Mechanical Characterization. 82, Porto Alegre: AOCS, 2005.

1. A wax-like formulation comprising in percent by weight of the total formulation:
from about 20% to about 86% of gum rosin;
from about 12% to about 80% of a fatty alcohol or polyol;
from about 0.1% to about 4% of phosphoric acid;
from about 0.1% to about 3% of an antioxidant.

2. The wax-like formulation of claim 1, wherein the fatty alcohol is a long-chain alcohol having from 6 to 40 carbon atoms and optionally further contains lesser quantities or traces of longer-chain primary alcohols of up to 58 carbons.

3. The wax-like formulation of claim 1, wherein the fatty alcohol is a polyol having from 4 to 40 carbon atoms and optionally further contains lesser quantities or traces of longer-chain primary alcohols of up to 58 carbons.

4. The wax-like formulation of claim 1, wherein the antioxidant prevents or minimizes oxidation and/or color darkening of the formulation.

5. The wax-like formulation of claim 4, wherein the antioxidant is selected from:
butylated hydroxytoluene (BHT), a blend of tris(2,4-ditert-butylphenyl)phosphite and pentaerythritol tetrakis[3-[3,5-di-tert-butyl-4-hydroxyphenyl]propionate], or any mixtures thereof.

6. The wax-like formulation of claim 1, wherein the fatty alcohol or polyol is selected from: cetyl alcohol, stearyl alcohol, UNILIN™ 350, UNILIN™ 425, 1,4-butanediol, 1,6-hexanediol, 1,10-decanediol, or any mixtures thereof.

7. The wax-like formulation of claim 6, wherein the fatty alcohol is stearyl alcohol.

8. The wax-like formulation of claim 1, wherein the antioxidant is BHT or Irganox B-225.

9. A wax-like formulation comprising in percent by weight of the total formulation:
from about 47% to about 52% of gum rosin;
from about 46% to about 51% of stearyl alcohol;
from about 0.5% to about 2% of phosphoric acid;
from about 0.5% to about 2% of BHT or Irganox B-225.

10. A one-pot process for preparing the formulation of claim 1, the process comprising the steps of:
i) melting the gum rosin in the reaction vessel with prior adding of the antioxidant under inert atmosphere, until temperature is around 100° C., then mixing is started as soon as the material is fluid enough;
ii) adding slowly the fatty alcohol or polyol, and letting it melt and mix with the gum rosin;
iii) adding the phosphoric acid and let the temperature raises between 120° C. and 280° C. accordingly to the desired esterification degree;
iv) monitoring the temperature in the reaction vessel constantly during the reaction process and applying a mild vacuum to remove water produced in the reaction;
v) letting the reaction proceed at the set temperature for 3 to 12 hours accordingly to the desired esterification degree.

11. The one-pot process of claim 10, wherein the fatty alcohol is a long-chain alcohol having from 6 to 40 carbon atoms and optionally further contains lesser quantities or traces of longer-chain primary alcohols of up to 58 carbons.

12. The one-pot process of claim 10, wherein the fatty alcohol is a polyol having from 4 to 40 carbon atoms and optionally further contains lesser quantities or traces of longer-chain primary alcohols of up to 58 carbons.

13. The one-pot process of claim 10, wherein the antioxidant prevents or minimizes oxidation and/or color darkening.

14. The one-pot process of claim 13, wherein the antioxidant is selected from: butylated hydroxytoluene (BHT), a blend of tris(2,4-ditert-butylphenyl)phosphite and pentaerythritol tetrakis[3-[3,5-di-tert-butyl-4-hydroxyphenyl]propionate], or any mixtures thereof.

15. The one-pot process of claim 10, wherein the fatty alcohol or polyol is selected from: cetyl alcohol, stearyl alcohol, UNILIN™ 350, UNILIN™ 425, 1,4-butanediol, 1,6-hexanediol, 1,10-decanediol, or mixtures thereof.

16. The one-pot process of claim 10, wherein the fatty alcohol is stearyl alcohol.

17. The one-pot process of claim 10, wherein the antioxidant is BHT or Irganox B-225.

18. The wax-like formulation of claim 1, which has undergone a hydroxylation process comprising and/or consisting of:
i) adding formic acid (industrial grade 85%) in a 3:1 molar relation to the expected moles of double bonds in the wax-like material, applying vigorous mechanical agitation and mild heating (40° C. to 50° C.);
ii) adding hydrogen peroxide dropwise (industrial grade 30%) in a 1.5:1 molar relation to the expected moles of double bonds of the wax-like material for 30 minutes.
iii) raising the temperature to 65° C. and controlling the temperature for 2 to 4 hours according to the desired degree of hydroxylation.
iv) at the end of the reaction time adding a 10% w/v aqueous sodium thiosulfate solution and letting it react with the remaining hydrogen peroxide for 30 minutes under agitation;
v) dissolving the mixture with sufficient ethyl ether to extract the organic phase and neutralizing with a 10% w/v solution of sodium carbonate until neutral pH; evaporating the solvent under vacuum.

19. The wax-like formulation of claim 1, comprising at least one of the following in percent by weight of the total formulation:
(a) from about 47% to about 52% of gum rosin;
(b) from about 46% to about 51% of a fatty alcohol or polyol;
(c) from about 0.5% to about 2% of phosphoric acid;
(d) from about 0.5% to about 2% of an antioxidant.
